(19) United States
(12) Patent Application Publication
(10) Pub. No.: US 2008/0024322 A1
(43) Pub. Date: Jan. 31, 2008

(54) Method and Arrangements for Increasing the Security of Transponder Systems, Particularly for Access to Automobiles

(75) Inventors: Karl-Ragmar Riemschneider, Hamburg (DE); Horst Roehm, Hamburg (DE); Matthias Wendt, Wuerselen (DE); Thomas Durbaum, Baiersdorf (DE); Achim Hilgers, Alsdorf (DE); Rainer Pietig, Aachen (DE); Heiko Pelzer, Erkelenz (DE)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: Koninklijke Philips Electronics N.V., Eindhoven (NL)

(21) Appl. No.: 10/562,249

(22) PCT Filed: Jun. 17, 2004
(86) PCT No.: PCT/IB04/50933

§ 371 Date: Jun. 21, 2007

(30) Foreign Application Priority Data
Jun. 25, 2003 (EP) 03101873.2

(51) Int. Cl. G07C 9/00; G06K 19/07; G06K 7/00

(52) U.S. Cl. 340/904; 340/5.61

(57) ABSTRACT

It is proposed that passive wireless transponder systems used in the context of procedures for access identification be provided with signaling that can be perceived by human beings. This also makes it possible to detect that a relay attack, which is difficult to prevent, is being carried out. Attention is also drawn to other types of manipulative interference with the communication and to certain problems with the high-frequency transmission. By the employment of comparatively inexpensive and highly reliable means, this near-simultaneous perception of an identifying process for access purposes produces a very effective reduction in such threats to the security of the system. Other simple measures may have an advantageous effect in connection therewith. The signaling may also assist an ergonomic process. For example, an automobile entry or access system that is not specifically actuated, referred to as a passive keyless entry system, may be improved.

The invention is based on a method and an arrangement of the kind defined in the main claim and relates to transponder systems or remote control systems employing high-frequency message transmission between a small device and a base station, which systems operate without being explicitly and deliberately actuated, at least in the case of certain functions. It is merely coming within the communication range that results in communication taking place and that is able to trigger the particular action concerned.

Such systems are referred to as passive. In the particular case of systems for giving access to automobiles, the term “passive keyless entry systems” is widely used. Systems that may be instanced as passive systems are, in particular, systems for giving access to automobiles, to other physical objects and areas, to electronic devices, machines, vehicles, installations and facilities and for giving authorizations for IT and telecommunication functions, but also systems for identifying people, for logging hours worked, and for logistics operations on objects and systems that perform ticketing and payment functions.

Passive entry or access systems are notable for the particular convenience to the user of the procedure by which authorization for access is given electronically. In such systems, the person authorized to have access generally carries or wears a small device for identification purposes in or on his clothing. The small device may be produced in various forms such as, for example, a chip card, key, remote control, key fob or badge. In the following context, it will also be referred to for short as a transponder. In the present connection it is immaterial whether the transponder does or does not have an energy source of its own (generally a battery).

The base station is able to communicate with the transponder over a distance ranging from several decimeters to a few meters when the latter is in the access zone. In the case of access to automobiles, this zone is in front of a door of the automobile.

During the course of the communication, cryptographic procedures are used in modern-day designs to achieve identification that is secure and difficult to imitate. If the identification process is successful, access is given without any additional action on the part of the wearer or carrier of the transponder. The electric central locking system of the automobile is opened, for example.

The widespread introduction of passive entry systems in automobiles can be expected in the fairly near future and such equipment is already available for certain vehicle models. The term “Passive Keyless Entry”, or PKE for short, is commonly used in this context.

The known passive transponder systems are difficult to protect against illicit access gained by relay attack. The assumption in this case is that an electronic attack is made on the system in which signals are transmitted between the base station and the transponder even though the latter—and hence the person authorized to have access—is outside the access zone.

Many proposed solutions for overcoming this problem have become known. Ones that will be cited as examples are DE 40 20 445 C2, WO 00/12846, EP 0823 520 A2, DE 199 49 970 A1, DE 197 28 761 C1, DE 198 24 528 C1, WO 00/12848, WO 01/25060 A2, DE 199 39 064 A1, EP 1 136 955 A2, US 2001 033 222 A1 and JP 2001 342 758 AA.

An example of a way of fending off a relay attack that will be cited is German application laid open to public-inspection DE 100 08 989 A1. In this, use is made of the FMCW (Frequency Modulated Continuous Wave) modulation method that is known from radar technology. In other solutions, it is proposed that the transit time on the radio transmission path be measured or limited. Because this transit time is in the range of only a few nanoseconds, determining it is no trivial matter with the present-day means available in the field of transponder technology.

What is common to the known proposals is that they are intended to make attacks difficult or to rule them out. Considerable technical circuitry and cost is generally required for this purpose. What are often proposed are methods of measurement that can only be made sufficiently robust when special measures are taken.

In the case of the method according to the invention, it is possible for security to be increased by virtue of the fact that signaling perceptible to human beings takes place as part of the communication process between the base station and the small device.

With the method according to the invention, illicit access is not ruled out but is merely prevented, at the outset, from being able to take place without its being noticed by the person authorized to have access. This at least increases the risk that the electronic attack and the potential intruder will be detected and recognized or apprehended, which will have a deterrent effect. The risk will be directly averted to a very large degree in this way.

If the person authorized to have access notices an attack, it will be possible for him to put in hand measures that will enable the illicit entry itself or the intended aim, the consequences or a repetition to be frustrated.

The invention can be implemented at considerably less cost and with considerably less circuitry than the majority of previously known solutions for safeguarding against relay attack. Appreciably higher reliability can also be expected than with many of the previously published solutions. No great exactness is called for on the part of components, frequencies or the like. As a result, inexpensive and well-proven means can be employed.

The solution according to the invention does not call for any additional wireless communication that may possibly be subject to approval or may require some further infrastructure (such as mobile radio networks or GPS). The invention can be applied internationally without any changes, which is not possible with some of the known methods because of the different frequency bands and bandwidths for the radio transmission.

The perception can be brought about in particular by the emission of sound and/or light as signaling. Where light is used, the transponder has to be worn or carried in an exposed position as a badge, identity-card tag or armband or on the surface of the clothing.

To assist perception, further measures may be added, these including perceptible vibrations, mechanical changes in shape that are clearly noticeable or tactile stimuli (the effects of forces on, or opposing forces set up by, controls), and possibly too electrical or thermal stimuli and in special cases the emission too of fragrant or unpleasant smelling substances.

The perceptible signaling may originate from the transponder and/or the access system (e.g. the automobile) and may be received and analyzed by whichever is on the other side. In the embodiments that are described below, this will be elucidated by way of example with reference to access to automobiles.

In a first embodiment of the invention, the perceptible signaling is emitted by the base station. Provision may be made in this case for the small device to receive and analyze at least part of the signaling. In this embodiment the base station, i.e. the automobile, emits perceptible signaling. When this is done, the signaling is both noticed by the human being and received by the transponder and included in the analysis made for the purposes of the accessing process.

In this way, the wake-up function that is already standard for the transponder may, for example, be performed by means of sound signals rather than by means of high-frequency signals (long-wave transmission is often used). Provision may, however, also be made for the signaling only to begin if at least part of the identification has already been completed, to enable signaling to take place only if the transponder(s) is/are the relevant one(s) or the base station matches, as the case may be. For this purpose, provision is made for the small device to conclude the communication in a secure manner if the signaling too has been received.

The signaling will be required even in the event of illicit access by relay attack. This access too will thus become perceptible and will not remain unnoticed as it was previously.

In a second embodiment, the perceptible signaling is emitted by the small device. When this is the case, provision may be made for the base station to receive and analyze at least part of the signaling. The transponder device has a signaling means that emits a perceptible message whenever there is an accessing process—i.e. even if there is an illicit accessing process.

The message may, for example, be a characteristic sequence of tones given by a piezo audio emitter. The effect of the sequence of tones may well be boosted by further types of signaling, for example by a pulsing vibratory message.

It is also possible for the two embodiments to be combined, meaning that both the transponder and the automobile emit signals.

The measures described in the other dependent claims make possible advantageous refinements and improvements of the invention specified in the main claim. Other claims relate to arrangements according to the invention.

Accessing processes that have not been concluded, are incomplete or have been broken off can also be signaled. Under certain circumstances this may be interpreted as an indication of attempted illicit access. The person authorized to have access can react in the light of the situation that exists. If he expects there to be a repeat, the transponder and hence the passive entry function can be switched off and/or action can be taken to have a check made and in certain cases even an arrest.

The transponder may have an input function (e.g. a press-key) that sets the automobile to a state that wards off the intruder. This may include the triggering of an alarm system or the locking of the vehicle. In particular, the trunk lid, filler cap, glove compartment and all the doors (including or not the entry door) may be locked in such a way that they can only be unlocked again by an explicit action that is only possible for the person authorized to have access or for security personnel (use of a key, input of a code).

In this state of alarm, it is conceivable for the intruder to be marked with dyes or odoriferous substances, for example by the emission of such at controls or handles.

Provision may also be made for locking or alarming of this kind to be maintained for a period (e.g. 15 minutes) that will be a deterrent to the intruder. Something comparable may apply in cases where the immobilizer is put into operation or where valuable equipment, fittings and accessories are blocked. In this way, navigation systems, on-board computers, entertainment and information systems (radio, video, internet) may be stopped from functioning until unlocked, window lifters and belt locks may be closed, the pumping of fuel or the firing of the engine may be prevented, and the brakes and steering may be blocked.

By means of an off-switch, the person authorized to have access may bar the passive access function temporarily. This is useful at times when the signaling would be a nuisance, such as when going to the theater, for example. The same is true when the signaling cannot be noticed because the person is not carrying the transponder device with him. The place of the off-switch may be taken by a cover, case or box for the transponder that is impenetrable to high-frequency transmissions, or by a control function in the vehicle, such as, for example, a special long-term parking or holiday safeguard.

A search or test mode can be set into which access is not allowed but the signaling is triggered as soon as a communication takes place. This may, for example, be implemented in the form of an incomplete or altered communication of the access data.

This mode can be used to find the transponder or the vehicle from a sufficiently short distance. Also, special search devices may provoke only the signaling, at the time of hunts by the authorities or checks, for example. This function may be a major deterrent to potential thieves.

In normal everyday use, the signaling is intended mainly to assist an ergonomic process. Because of the additional things that are perceived, the user learns the passive entry function more quickly. There is assistance with the movements that have to be performed because there is perceptible feedback. There are many cases where something comparable has proved a success, such as, for example, in the case of momentary-contact switches that give an additional audio signal or have indicator lights.

The absence of the signaling, or its incompleteness or a difference from its normal course may indicate a problem on the high-frequency transmission path (interference in the transmission band, shadowing) and may for example cause further attempts to be made to gain access with a change in the position of the transponder. The signaling means may also assume responsibility for a diagnostic function for other purposes, and may for example give an indication that a battery is exhausted.

Security against other electronic attacks can also be increased with the help of the signaling. Attacks of this kind include, in particular, ones aimed at gaining knowledge of the parameters, cryptological operation or codes of the transponder and/or base station by way of unnoticed tapping into their signals. With the help of this information, attempts could be made to imitate the signals or the operation, to re-radiate the signals, or to perform crypto-attacks (decryptions). At the present time, the view taken by experts generally is that risks of this kind are fairly small because all manufacturers are using well thought out cryptographic procedures, measures for ensuring secrecy and other organizational and technical safeguards. In view of the long working life that passive entry systems can be expected to have and the very widespread use than can be expected to be made of them, losses of integrity of some kind cannot be totally ruled out. Apart from its having the primary advantages that have been explained, there is also undoubtedly a preventive aspect to safeguarding with the help of the invention and attention should be paid to this, as a precaution, in decisions on long-term system designs that are being made today.

Other defensive measures against electronic attacks are greatly assisted by the invention. By use in combination with such methods, the disadvantages of the known methods can be appreciably reduced. In this way, far higher error rates and lower accuracies can be permitted. The possibility of signaling failed or frustrated attacks increases the safeguarding effect.

Implementation of the invention boosts the attentiveness of the user to the novel function, and makes it easier for him to become accustomed to day-to-day use of the convenient passive procedure for which there is no actuating function.

It is not necessary for the purchaser of a vehicle to be given any detailed understanding of the exact nature of the threat posed by electronic attacks. The deterrent effect of the signaling comes into play even without such an understanding. It can be assumed that a potential attacker will have the appropriate specialized knowledge needed to recognize the resulting risk of discovery and the other points that provide safeguards.

In the unlikely event of there still being a threat, the user too can be quickly acquainted with the appropriate rules of behavior and countermeasures. When journeying to countries or regions where there is a risk, the passive function could be selectively not used. For this purpose, provision may be made in the arrangement according to the invention for there to be on the small device a control for at least temporarily deactivating the wireless transmission.

Access, identification, logging, ticket and payment systems employing wireless identification where no deliberate, active action has to be taken can also be improved by means of the invention. In this case too, comparable advantages from the point of view of security and operation can be achieved with little circuitry and cost by using the invention.

These and other aspects of the invention are apparent from and will be elucidated with reference to the embodiments described hereinafter.

In the drawings:

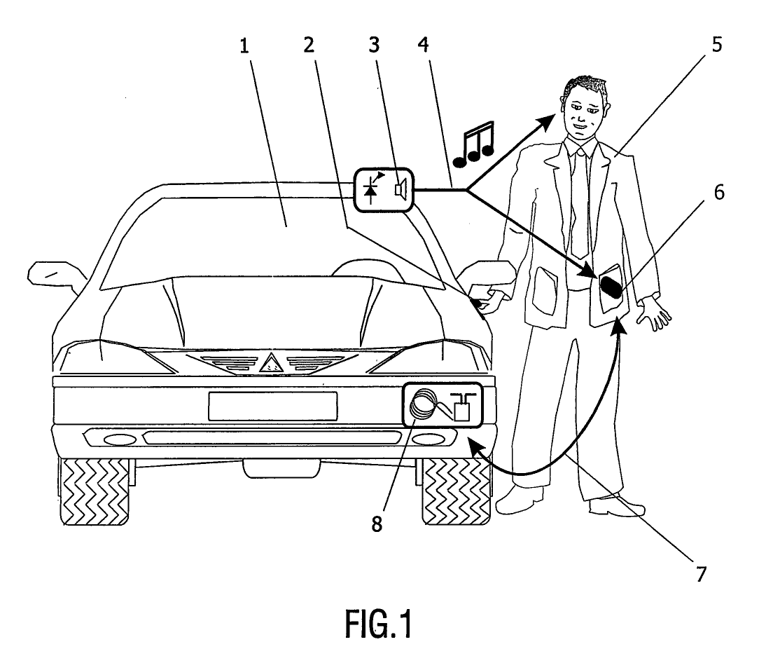

FIG. 1 is a schematic representation of the signaling when emitted by the base station (the automobile in this case).

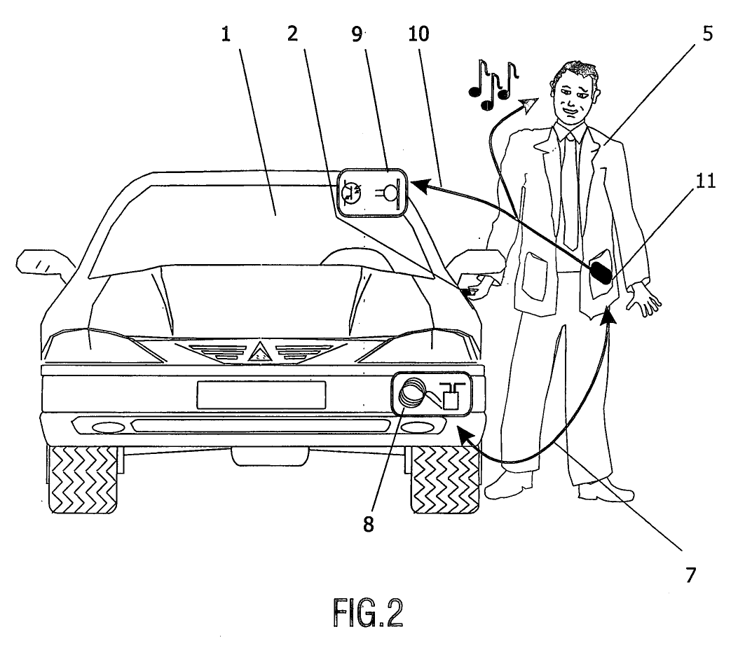

FIG. 2 is a schematic representation of the signaling when emitted by the transponder.

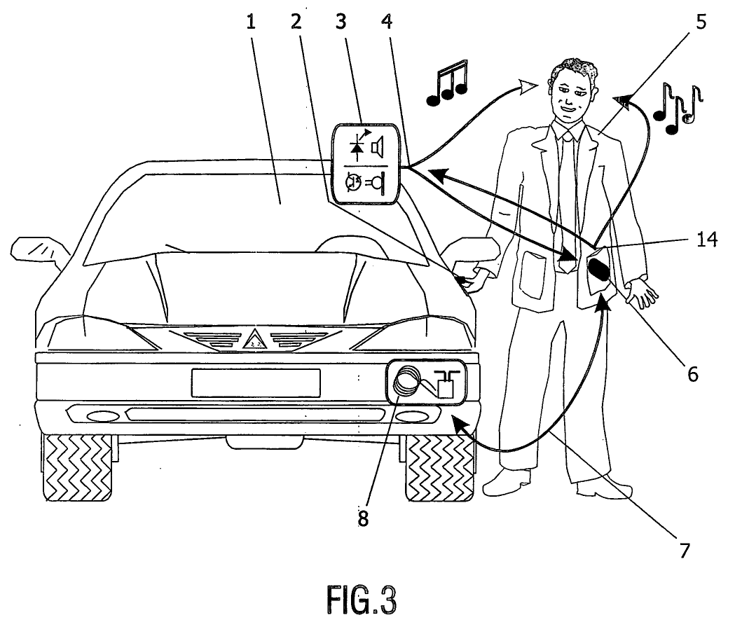

FIG. 3 is a schematic representation of the signaling when emitted both by the base station (the automobile in this case) and by the transponder.

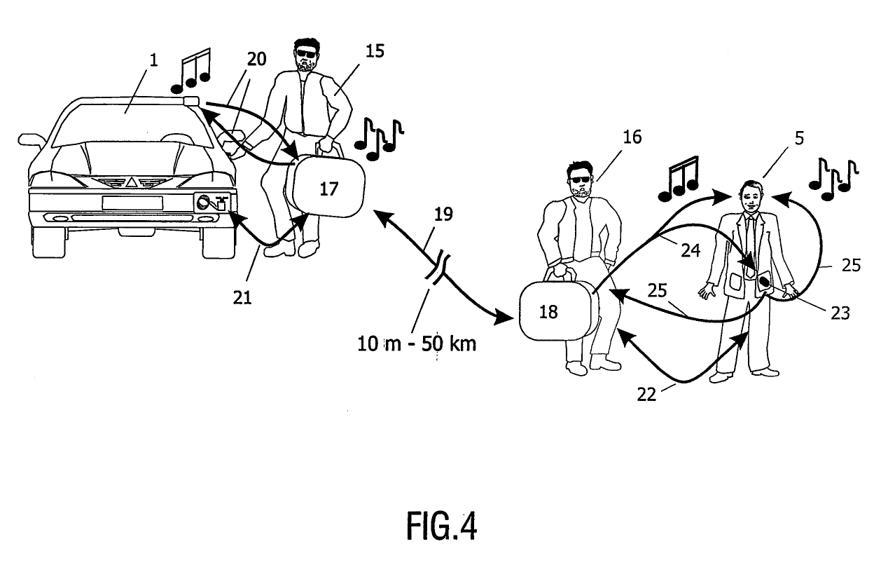

FIG. 4 shows an imaginary relay attack and the advantageous—deterrent—effect of the signaling and

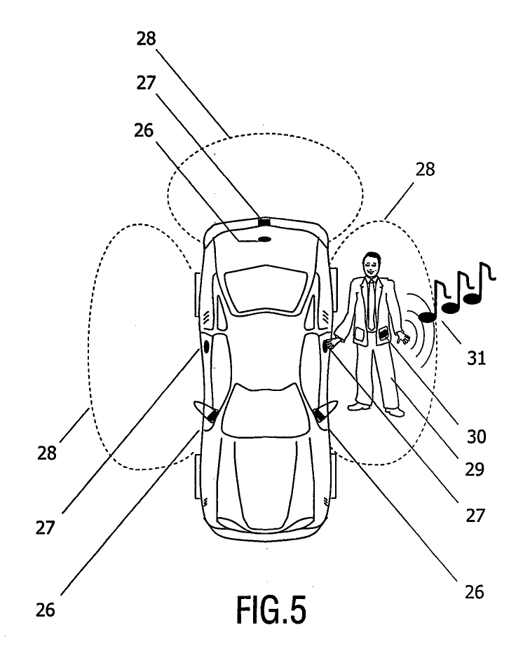

FIG. 5 is a schematic representation of an embodiment employing signaling in specific spatial access zones.

FIG. 1 is a schematic representation of the first embodiment. From the vehicle 1, perceptible signaling 4, such as, for example, a sequence of tones or a light signal, is emitted. This signaling is emitted by a signal emitter 3. It is perceived by the person 5 authorized to have access—the carrier or wearer of the transponder—and at the same time is received and analyzed by the transponder 6. For this purpose, the latter may be fitted with a suitable receiver, such as, for example, an opto-electrical or an acoustic one.

The wireless communication 7 is further effected between the transponder 6 and the base station 8. This communication uses alternating fields in different frequency bands and it cannot be perceived.

To save energy, provision may be made for the entire function not to be switched on until the door handle 2 has been operated. Other points to indicate that the access zone has been entered may also be used (light barriers, motion sensors, analysis of fields).

The signal emitter 3 and the base station 8 may be fitted at different points in the vehicle or as a combined sub-assembly—e.g. in the door mirror or on the door handle 2.

FIG. 2 is a schematic view of the second embodiment. From the transponder 11, perceptible signaling 10, such as, for example, a sequence of tones or a light signal, is emitted. This signaling is emitted by a signal emitter integrated into the transponder 11. It is perceived by the person 5 authorized to have access, who is carrying the transponder in his pocket, and at the same time is received and analyzed by a signal sensor 9 in the vehicle 1. The wireless communication 7 between the transponder 11 and the base station 8, which cannot be perceived, continues.

In this embodiment, security is substantially increased even if the signal sensor 9 is dispensed with. The signaling may then be performed only by vibration of, and/or by tactile stimulus (change of shape) by, the transponder device or by similar measures, alone or as a supplement. Where a signal sensor 9 does exist, the signals used are chiefly sound or light signals. Attentiveness and the ergonomic effect can be further increased if tactile, visible or audible stimuli are given at the door handle 2 in synchronization or in a matched rhythm. The handle may also perform the function of an on-switch.

FIG. 3 is a schematic representation of the third embodiment. From the transponder 6, perceptible signaling 14, such as, for example, a sequence of tones or a light signal, is emitted. This signaling is emitted by a signal emitter integrated into the transponder 11. It is perceived by the person 5 authorized to have access, and at the same time is received and analyzed by a combined signal emitter and sensor 12 in or on the vehicle 1.

The combined signal emitter and sensor 12 may also emit signaling 13 that is then, once again, both perceived and also received and analyzed by the transponder 6. For this purpose, the transponder 6 has not only the signal emitter mentioned but also a signal sensor.

The two signals 13 and 14 may be of the same kind or different. They may be particularly clearly noticeable as a result of further stimuli temporally connected with them, originating from the transponder 6 and the vehicle 1.

FIG. 4 represents an imaginary electronic relay attack and the advantageous effect of the signaling.

One of the two ends of the extended radio transmission path 19 used in the relay attack is situated at the vehicle. This end is shown here schematically as a relay station 17 that is hidden in the suitcase carried by a potential intruder 15. The signals 21 that are normally exchanged between the transponder and base station are now passed to the other end of the extended radio transmission path 19, and sent back again, via an intermediate point. The other end of the extended path takes the form of, for example, a relay station 18 disguised as a suitcase that is carried by an accomplice 16 of the intruder. The accomplice 16 is situated sufficiently close to the person 5 authorized to have access, at a time when the latter is no longer able to see his vehicle.

From this end, the radio signals 22 that have been transmitted via an intermediate point are re-emitted, and picked up in the other direction. In this way, a base station in the immediate vicinity of the transponder 23 is simulated and the transponder 23 is inveigled into behaving in the appropriate way. The transmissions from the transponder are transmitted back to the actual base station. In this way, the vehicle 1 can be opened, without authority, even though the person 5 authorized to have access is a long way away from the access zone. Distances of between 10 m and 50 km or more are conceivable. The extended radio transmission path can employ any desired transmission mediums (radio link, co-axial cable, telephone) that have the requisite bandwidth.

Hitherto, electronic attack of this kind has been a particular threat because the process can take place entirely unnoticed, i.e. there is no appreciable risk of discovery either for the intruder 15 or for the accomplice 16.

However, a hypothetical attempt by a potential intruder 15 also to give the signaling according to the invention in connection with the electronic attack will almost inevitably lead to his being discovered. The signaling 20 would have to be transmitted between the vehicle 1 and the relay station 17. Also, the relay station 18 would have to transmit the signaling 24 on to the person 5 authorized to have access and to the transponder 23.

In the event of the signal being emitted by the relay station 18, the accomplice 16 will be revealed in the above example. The attention of the person 5 authorized to have access will also be drawn by the emission 25 of the signal from the transponder 23 and he will be able to put in hand a range of countermeasures.

If on the other hand the intruder accepts the risk of discovery (acquires the transponder by robbery or theft, breaks in by force), then he will hardly choose to make a complicated electronic attack. A risk of this sort has to be reduced by other means.

FIG. 5 is a schematic representation of an embodiment where the signaling function operates if a person enters or is in specific spatial access zones.

A base station 26 or a plurality of antennas may be fitted round an automobile in the region of the doors (side and rear). As a result of the range of the transponders, access zones approximately 1 m to a maximum of approximately 5 m in extent are formed.

As a variant of the second embodiment, signaling can take place as soon as these access zones 28 are entered. The person authorized to have access can be given a forceful reminder by the signaling that he is just being passively identified. He can operate the door handle 26 without having to take any further action, which handle 26 unlocks in the event of him being satisfactorily recognized as part of the identification.

If the person authorized to have access is not reminded in this way, either the passive function has been deactivated or there is an operating fault. In both cases he has to take some active steps.

If, however, the person authorized to have access receives signaling well outside the access zone of his vehicle,-unauthorized access is imminent or is taking place at that moment. The passive identification function performed by the transponder can be deactivated by simple operation of a control. Instead of this, an alarm function can be triggered or other countermeasures put in hand. Provision may be made for the door handle not to be operable for the whole time after the signaling successfully activates the opening process but only in a given time slot. Permanent operation of the door handle should not be permitted anyway. From an ergonomic point of view, the signaling should be satisfactorily matched to the expiry of the period allowed for door opening.

1. A method for increasing the security of transponder systems employing wireless transmission between at least one base station and at least one small device that a person can carry with him or her, a communication that establishes that the small device is spatially close taking place between the basis station and the small device, characterized in that signaling perceptible to human beings takes place as part of the communication process between the base station and the small device.

2. A method as claimed in claim 1, characterized in that the perceptible signaling is emitted from the base station.

3. A method as claimed in claim 2, characterized in that the small device receives and analyzes at least part of the signaling.

4. A method as claimed in claim 3, characterized in that the small device concludes the communication in a secure manner if the signaling too has been received.

5. A method as claimed in claim 1, characterized in that the perceptible signaling is emitted from the small device.

6. A method as claimed in claim 4, characterized in that the base station receives and analyzes at least part of the signaling.

7. A method as claimed in claim 6, characterized in that the base station only performs an action associated with the communication if the signaling too has been received

8. A method as claimed in claim 1, characterized in that an action that should normally be provoked by the communication is embargoed by the operation of a control at the small device and by a transmission of data to the base station.

9. A method as claimed in any claim 1, characterized in that an absence of signaling and/or altered signaling at the small device indicates an operating fault in the transmission process.

10. A method as claimed in claim 1, characterized in that an alarm is triggered by the operation of a control at the small device and by a transmission of data.

11. A method as claimed in claim 1, characterized in that an additional mode of operation allows communication to be established between the base station and small device but only the signaling to be performed, and normal operation (authorization of access, identification, payments, logging and the like) to be embargoed at least until a particular deliberate action (e.g. operation of a special control, input of a code, mechanical unlocking, and the like) has been performed and/or until an interval of time has expired.

12. A method as claimed in claim 1, characterized in that the device is prevented from operating, at least temporarily, by controls and/or by a cover at least parts of which are impenetrable.

13. A method as claimed in claim 1, characterized in that the signaling occurs when an access zone is entered and/or there is a presence in the access zone and takes place temporally before an identification process.

14. An arrangement for increasing the security of transponder systems employing wireless transmission between at least one base station and at least one small device that a person can carry with him or her, a communication that establishes that the small device is spatially close taking place between the basis station and the small device, characterized in that at least one emitter for signaling perceptible by human beings is provided in the base station, which emitter is able to be activated by the communication.

15. An arrangement for increasing the security of transponder systems employing wireless transmission between at least one base station (8) and at least one small device that a person can carry with him or her, a communication that establishes that the small device is spatially close taking place between the basis station and the small device, characterized in that at least one emitter for signaling perceptible by human beings is provided in the small device, which emitter is able to be activated by the communication.

16. An arrangement as claimed in claim 15, characterized in that a control for deactivating the wireless transmission at least temporarily is present on the small device.

17. An arrangement as claimed in claim 15, characterized in that a control for triggering protective measures in the context of a technical system that includes the base station is present on the small device.

18. An arrangement as claimed in claim 15, characterized in that a control for triggering an alarm is present on the small device.

19. An arrangement as claimed in claim 14, characterized in that a receiver for the signaling emitted by the base station and an analyzing means are present in the small device.

20. An arrangement as claimed in claim 15, characterized in that a receiver for the signaling emitted by the small device and a matching analyzing means are present at the base station.

21. An arrangement for increasing the security of transponder systems employing wireless transmission between at least one base station and at least one small device that a person can carry with him or her, a communication that establishes that the small device is spatially close taking place between the basis station and the small device, characterized in that a control for deactivating the wireless transmission, at least at times, is present on the small device.
